(19) United States
(12) Patent Application Publication
(10) Pub. No.: US 2022/0343163 A1
(43) Pub. Date: Oct. 27, 2022

(54) LEARNING SYSTEM, LEARNING DEVICE, AND LEARNING METHOD

(71) Applicant: NEC Corporation, Minato-ku, Tokyo (JP)

(72) Inventor: Makoto TAKAMOTO, Tokyo (JP)

(73) Assignee: NEC Corporation, Minato-ku, Tokyo (JP)

(21) Appl. No.: 17/762,418

(22) PCT Filed: Sep. 30, 2019
(86) PCT No.: PCT/JP2019/038498

§ 371 Date: Mar. 22, 2022

(51) Int. Cl. G06N 3/08; G06N 3/04

(52) U.S. Cl. CPC G06N 3/08; G06N 3/0454

(57) ABSTRACT

A learning system includes teacher DNN feature extraction unit extracting a feature of each of a plurality of training data, teacher DNN estimate calculation unit calculating a first estimate of a label corresponding to each of the training data, student DNN feature extraction unit extracting a feature of each of the training data, student DNN estimate calculation unit calculating a second estimate of a label corresponding to each of the training data, noisy label correction unit determining whether or not the label corresponding to the training data is a label including a noise, based on the label corresponding to the training data and the first estimate, and update unit updating weights in the student DNN so as to reduce a difference between the feature extracted by the teacher DNN feature extraction unit and the feature extracted by the student DNN feature extraction unit while decreasing an influence of the label including the noise.

### TECHNICAL FIELD

The present invention relates to a learning system and a learning device including a deep neural network, and a learning method using the deep neural network.

### BACKGROUND ART

A deep neural network (hereinafter, referred to as a DNN (Deep Neural Network)) is a neural network in which an intermediate layer comprises a plurality of layers. One example of a DNN is a Convolutional Neural Network (CNN) having two or more hidden layers.

In a DNN, many parameters are used. Therefore, the calculation amount in the computer that realizes a DNN becomes large. As a result, it is difficult to apply a DNN to mobile devices with relatively low computing power (calculation speed and storage capacity).

In order to reduce the calculation cost, i.e., the calculation amount, it is possible to reduce the number of hidden layers or the number of nodes in the hidden layers to reduce the number of dimensions of a DNN. By reducing the number of hidden layers and the number of nodes, the size of the DNN model can be reduced. However, by reducing the size of the DNN model, the calculation amount is reduced, but the accuracy of a DNN is reduced.

Distillation as model compression is one of the methods to reduce the calculation cost while keeping the accuracy degradation. In distillation, a model is first trained by supervised learning, for example, to generate a teacher model. Then, a student model, which is a smaller model than the teacher model, is trained using the output of the teacher model instead of the correct answer label (refer to patent literature 1, for example).

Note that distillation is also introduced in non-patent literature 1.

### CITATION LIST

### Patent Literature

PTL 1: Japanese Translation of PCT International Application No. 2017-531255

### Non-Patent Literature

NPL 1: G. Chen et al, “Learning Efficient Object Detection Models with Knowledge Distillation”, 31st International Conference on Neural Information Processing Systems (NIPS2017)

### SUMMARY OF INVENTION

### Technical Problem

In the teacher data, A label may include a noise. The teacher data including a noise influences the accuracy of DNN. Patent literature 1 describes a student model trained by using the output of the teacher model instead of the correct answer label, but the teacher data including a noise is not considered in patent literature 1.

Non-patent literature 1 also describes a student model trained by using the output of the teacher model instead of the correct answer label. However, no measures for the teacher data including a noise are considered in the non-patent literature 1.

It is an object of the present invention to provide a learning system, a learning device, and a learning method that can efficiently make a student DNN learn information learned by a teacher DNN.

### Solution to Problem

The learning system according to the present invention is a learning system that uses a teacher DNN and a student DNN whose size is smaller than a size of the teacher DNN includes teacher DNN feature extraction means for extracting a feature of each of a plurality of training data, teacher DNN estimate calculation means for calculating a first estimate of a label corresponding to each of the training data, student DNN feature extraction means for extracting a feature of each of the training data, student DNN estimate calculation means for calculating a second estimate of a label corresponding to each of the training data, noisy label correction means for determining whether or not the label corresponding to the training data is a label including a noise, based on the label corresponding to the training data and the first estimate, and update means for updating weights in the student DNN so as to reduce a difference between the feature extracted by the teacher DNN feature extraction means and the feature extracted by the student DNN feature extraction means while decreasing an influence of the label including the noise.

The learning device according to the present invention is a learning device that uses a student DNN includes student DNN feature extraction means for extracting a feature of input data, student DNN estimate calculation means for calculating a plurality of estimates of labels corresponding to the input data, and output integration means for integrating the estimates, wherein weights of the student DNN feature extraction means are updated by teacher DNN includes teacher DNN feature extraction means for extracting a feature of each of a plurality of training data, teacher DNN estimate calculation means for calculating a first estimate of a label corresponding to each of the training data, noisy label correction means for determining whether or not the label corresponding to the training data is a label including a noise, based on the label corresponding to the training data and the first estimate, and update means for updating the weights in the student DNN so as to reduce a difference between the feature extracted by the teacher DNN feature extraction means and the feature extracted by the student DNN feature extraction means while decreasing an influence of the label including the noise.

The learning method according to the present invention is a learning method that uses a teacher DNN and a student DNN of whose size is smaller than a size of the teacher DNN includes extracting a feature of each of a plurality of training data as a teacher DNN feature, calculating a first estimate of a label corresponding to each of the training data, extracting a feature of each of the training data as a student DNN feature, calculating a second estimate of a label corresponding to each of the training data, determining whether or not the label corresponding to the training data is a label including a noise, based on the label corresponding to the training data and the first estimate, and updating weights in the student DNN so as to reduce a difference between the extracted teacher DNN feature and the extracted student DNN feature.

The recording medium according to the present invention is a computer readable recording media storing a learning program is recorded, the learning program causes a processor to execute a process of extracting a feature of each of a plurality of training data as a teacher DNN feature, a process of calculating a first estimate of a label corresponding to each of the training data, a process of extracting a feature of each of the training data as a student DNN feature, a process of calculating a second estimate of a label corresponding to each of the training data, a process of determining whether or not the label corresponding to the training data is a label including a noise, based on the label corresponding to the training data and the first estimate, and a process of updating weights in the student DNN so as to reduce a difference between the extracted teacher DNN feature and the extracted student DNN feature.

### Advantageous Effects of Invention

According to the present invention, it is possible to efficiently make a student DNN learn information learned by a teacher DNN.

### BRIEF DESCRIPTION OF DRAWINGS

FIG. 1 It depicts a block diagram showing a configuration example of a learning system of the first example embodiment.

FIG. 2 It depicts an explanatory diagram showing an example of making a student DNN learn from a teacher DNN in the first example embodiment.

FIG. 3 It depicts an explanatory diagram showing an example of a teacher DNN model.

FIG. 4 It depicts an explanatory diagram showing an example of a student DNN model.

FIG. 5 It depicts a flowchart showing an operation of the learning system of the first example embodiment.

FIG. 6 It depicts a block diagram showing a configuration example of a learning system of the second example embodiment.

FIG. 7 It depicts an explanatory diagram showing an example of making a student DNN learn from a teacher DNN in the second example embodiment.

FIG. 8 It depicts a block diagram showing an example of a computer with a CPU.

FIG. 9 It depicts a block diagram showing the main part of the learning system.

FIG. 10 It depicts a block diagram showing the main part of the learning device.

### DESCRIPTION OF EMBODIMENTS

### Example Embodiment 1

Hereinafter, a first example embodiment of the present invention is described with reference to the drawings. The learning system of the first example embodiment is a learning system in which a distillation technique is applied.

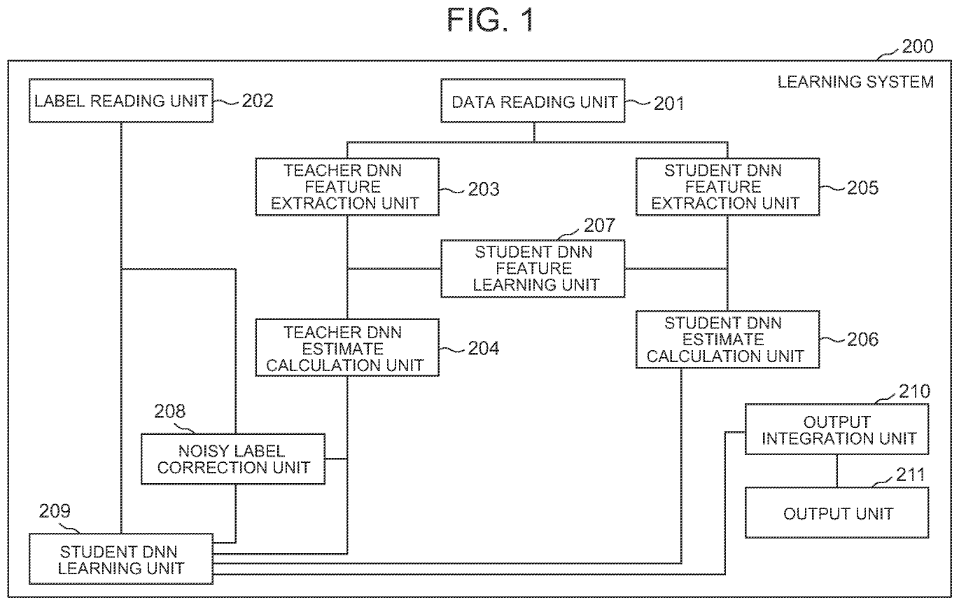

FIG. 1 is a block diagram showing a configuration example of a learning system. A learning system 200 of this example embodiment includes a data reading unit 201, a label reading unit 202, a teacher DNN feature extraction unit 203, a teacher DNN estimate calculation unit 204, a student DNN feature extraction unit 205, a student DNN estimate calculation unit 206, a student DNN feature learning unit 207, a noisy label correction unit 208, a student DNN learning unit 209, an output integration unit 210, and an output unit 211.

For example, data such as an image, a sound, a text, or the like is input to the data reading unit 201. The input data is temporarily stored in a memory. Thereafter, the data reading unit 201 outputs the input data to the teacher DNN feature extraction unit 203 and the student DNN feature extraction unit 205.

A label corresponding to the data input to the data reading unit 201 is input to the label reading unit 202. The input label is temporarily stored in a memory. The label reading unit 202 outputs the input label to the noisy label correction unit 208 and the student DNN learning unit 209.

The teacher DNN feature extraction unit 203 converts the data input from the data reading unit 201 into a feature of scalar type.

The teacher DNN estimate calculation unit 204 calculates a label estimate using the feature of scalar type input from the teacher DNN feature extraction unit 203.

The student DNN feature extraction unit 205 converts the data input from the data reading unit 201 into a feature of scalar type, similar to the teacher DNN feature extraction unit 203.

The student DNN estimate calculation unit 206 calculates a label estimate using the feature of scalar type input from the student DNN feature extraction unit 205. The student DNN estimate calculation unit 206 outputs a plurality of estimates for statistical average. The student DNN estimate calculation unit 206 outputs an estimate of the output from the noisy label correction unit 208, an estimate of the output from the teacher DNN estimate calculation unit 204, and the like.

The student DNN feature learning unit 207 receives the feature from each of the teacher DNN feature extraction unit 203 and the student DNN feature extraction unit 205, and calculates a function of the difference between features. Then, the student DNN feature learning unit 207 calculates a gradient that can reduce the value of the function. The gradient is used to update weights of the student DNN.

The noisy label correction unit 208 compares a label value input from the label reading unit 202 with a label estimate input from the teacher DNN estimate calculation unit 204. The noisy label correction unit 208 considers a label with a large difference between the label value and the label estimate to be an incorrect label (a label including a noise).

The noisy label correction unit 208 corrects the incorrect label. As a correction method, for example, it is possible to use the label estimate input from the teacher DNN estimate calculation unit 204 as it is as a corrected label. Note that the correction method is not limited to the method of using the label estimate input from the teacher DNN estimate calculation unit 204 as it is as a corrected label, other methods may also be used.

The student DNN learning unit 209 inputs the label from the label reading unit 202, inputs the label estimate from the teacher DNN estimate calculation unit 204, and inputs the corrected label from the noisy label correction unit 208. In addition, the student DNN learning unit 209 inputs the label estimate from the student DNN estimate calculation unit 206. For example, the student DNN learning unit 209 calculates a difference between the label estimate from the teacher DNN estimate calculation unit 204 and the label estimate (the estimate output from the teacher DNN estimate calculation unit 204) from the DNN estimate calculation unit 206, referring to the corrected label. The student DNN learning unit 209 calculates a gradient that reduces the value of the function and uses the gradient to update the weights of the student DNN. As a function, for example, mean squared error, mean absolute error, and Wing-Loss can be used.

The output integration unit 210 receives an output from the student DNN estimate calculation unit 206, and integrates the values thereof. An integration method is a statistical average, for example.

The output unit 211 inputs an output from the output integration unit 210 during the operation (operational phase) after the training phase (learning phase) is completed and outputs the output from the output integration unit 210 as the estimate of the student DNN.

The output integration unit 210 and the output unit 211 are utilized in the operational phase and need not be present in the training phase.

The teacher DNN (the teacher DNN feature extraction unit 203 and the teacher DNN estimate calculation unit 204 are included) is a relatively large size DNN model with a sufficient number of parameters to achieve the required accuracy in learning. As a teacher model, ResNet with a large number of channels and Wider ResNet, as an example, can be used. The size of the DNN model corresponds to the number of parameters, for example, but may also correspond to the number of layers, the feature map size, or the kernel size.

In addition, the size of the student DNN (the student DNN feature extraction unit 205, the student DNN estimate calculation unit 206, the student DNN feature learning unit 207 and the student DNN learning unit 209 are included) is smaller than the size of the teacher DNN. For example, the number of parameters in the student DNN is relatively small. The number of parameters in the student DNN is less than the number of parameters in the teacher DNN. For example, the student DNN is a DNN model of a size small enough that the student DNN can actually be implemented in a device in which the student DNN is supposed to be implemented. As an example, as the student DNN, a Mobile Net, and a ResNet and a Wider ResNet with a sufficiently reduced number of channels.

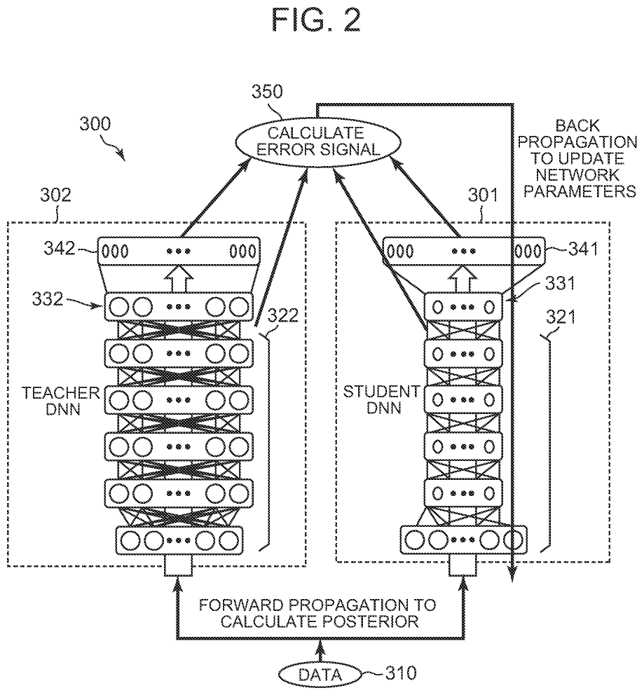

FIG. 2 is an explanatory diagram showing an example of making a student DNN learn from a teacher DNN. Referring to FIG. 2, an example of training (learning) a student DNN with a small number of parameters by using the output of the teacher DNN with a large number of parameters instead of a correct answer label will be explained.

In the learning system 300, the student DNN 301 inputs data from a data reading unit 310. The feature extraction unit 321 converts the data into a feature. The estimate calculation unit 331 converts the feature into an estimate 341. The data reading unit 310, the feature extraction unit 321, and the estimate calculation unit 331 correspond to the data reading unit 201, the student DNN feature extraction unit 205 and the student DNN estimate calculation unit 206 in the learning system 200 shown in FIG. 1. In other words, the learning system 300 is the same as the learning system 200 shown in FIG. 1, although the representation method is different.

The teacher DNN 302 inputs data from the data reading unit 310. The feature extraction unit 322 converts the data into a feature. The estimate calculation unit 332 converts the feature into an estimate 342. The data reading unit 310, the feature extraction unit 322, and the estimate calculation unit 332 correspond to the data reading unit 201, the teacher DNN feature extraction unit 203 and the teacher DNN estimate calculation unit 204 in the learning system 200 shown in FIG. 1.

In the learning system 300, the error signal calculation unit 350 calculates an error signal from each obtained feature and each converted estimate. The learning system 300 then updates the weights by back propagation to update the network parameters of the student DNN 301.

In the learning system 200 shown in FIG. 1, the processing of the error signal calculation unit 350 is performed by the student DNN learning unit 209.

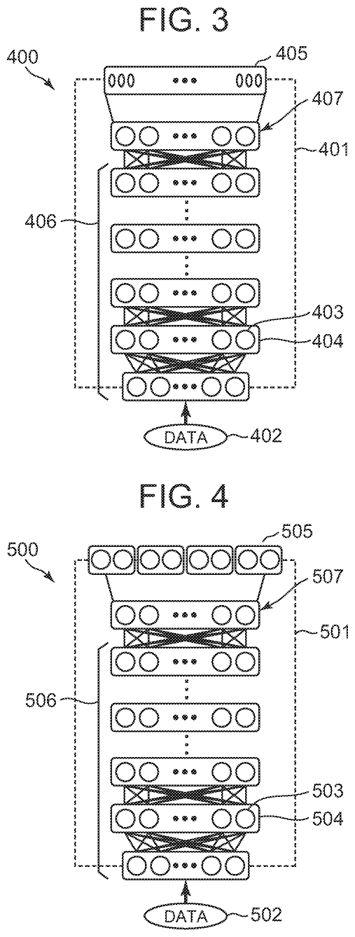

FIG. 3 is an explanatory diagram showing an example of a teacher DNN model.

A teacher DNN 401 in a teacher DNN model 400 includes a feature extraction unit 406 and an estimate calculation unit 407. The feature extraction unit 406 includes a plurality of hidden layers 404. The hidden layers comprise a plurality of nodes 403. Each node has a corresponding weight parameter. The weight parameters are updated by learning.

The data is supplied from the data reading unit 402. The feature extracted by the feature extraction unit 406 is output from the final layer of the feature extraction unit 406 to the estimate calculation unit 407. The estimate calculation unit 407 converts the input feature into a label estimate 405.

Note that the data reading unit 402, the feature extraction unit 406, and the estimate calculation unit 407 correspond to the data reading unit 201, the teacher DNN feature extraction unit 203 and the teacher DNN estimate calculation unit 204 in the learning system 200 shown in FIG. 1.

FIG. 4 is an explanatory diagram showing an example of a student DNN model.

A student DNN 501 in a student DNN model 500 includes a feature extraction unit 506 and an estimate calculation unit 507. The feature extraction unit 506 includes a plurality of hidden layers 504. The hidden layers comprise a plurality of nodes 503. Each node has a corresponding weight parameter. The weight parameters are updated by learning.

The feature extracted by the feature extraction unit 506 is output from the final layer of the feature extraction unit 506 to the estimate calculation unit 507. The estimate calculation unit 507 converts the input feature into a plurality of label estimates 505.

Note that the data reading unit 502, the feature extraction unit 506, and the estimate calculation unit 507 correspond to the data reading unit 201, the student DNN feature extraction unit 205 and the student DNN estimate calculation unit 206 in the learning system 200 shown in FIG. 1.

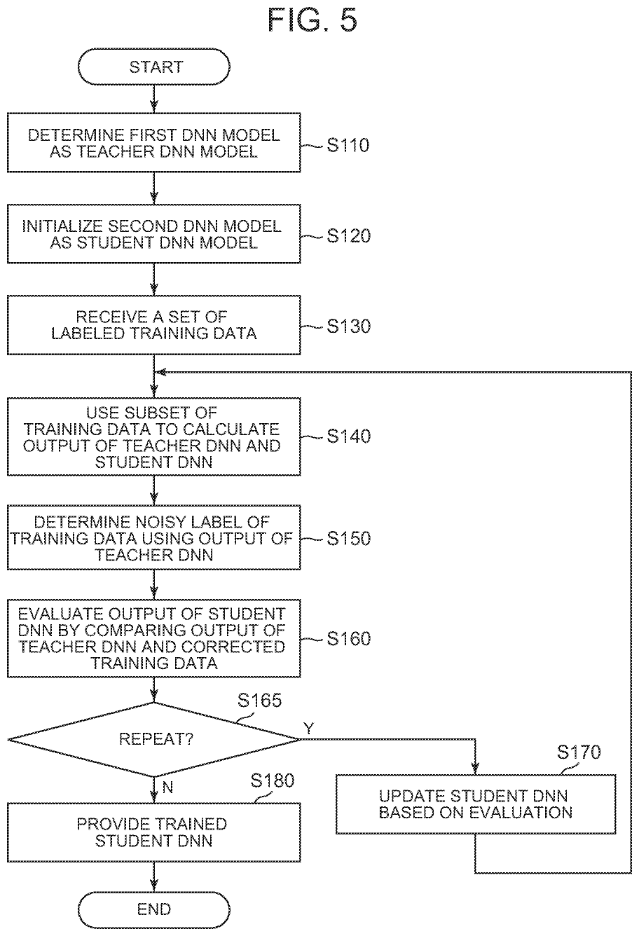

Next, the operation of the learning system 300 of the first example embodiment will be described with reference to the flowchart of FIG. 5.

First, the learning system 300 determines the first DNN model as a teacher DNN model (step S110). In the configuration example shown in FIG. 1, the teacher DNN includes the teacher DNN feature extraction unit 203 and the teacher DNN estimate calculation unit 204.

Next, the learning system 300 initializes the second DNN model as a student DNN model (step S120). In initializing, for example, an initial value is given using a normally distributed random number with mean 0 and variance 1. In the learning system 200 shown in FIG. 1, the student DNN model includes the student DNN feature extraction unit 205, student DNN estimate calculation unit 206, the student DNN feature learning unit 207 and the student DNN learning unit 209.

Then, the learning system 300 receives a set of labeled training data as input to the teacher DNN model and the student DNN model (step S130). In the learning system 200 shown in FIG. 1, a data reading unit 201 and a label reading unit 202 input the labeled training data. The data reading unit 201 and the label reading unit 202 maybe integrated. In the following description, the training data means the labeled training data.

In the learning system 300, the teacher DNN 401 and student DNN 501 use a subset of the received training data to calculate an output (step S140).

In the learning system 200 shown in FIG. 1, the output of the teacher DNN estimate calculation unit 204 corresponds to the output of the teacher DNN 401. The output of the student DNN estimate calculation unit 206 corresponds to the output of the student DNN 501.

Next, in the learning system 300, incorrect label data (noisy label) of training data is determined using the output of teacher DNN 401 (step S150). In the learning system 200 shown in FIG. 1, the noisy label correction unit 208 determines whether or not the label in the training data is incorrect.

In the learning system 300, the output of the student DNN 501 is evaluated by being compared with the output of the teacher DNN 401 and the corrected label of the training data (corrected label) (step S160). In the learning system 200 shown in FIG. 1, the student DNN learning unit 209 performs the evaluation.

In the learning system 300, it is determined whether or not to repeat the processes of step S140 to step S160 using certain determination criteria (step S165). As the determination criterion, for example, the mean square error between the output of the student DNN 501 and the label is calculated, and the value of the mean square error exceeds (or below) a certain threshold value is considered. In the learning system 200 shown in FIG. 1, the student DNN learning unit 209 performs the determination process of step S165.

In step S165, when it is determined to repeat, then in the learning system 300, the weight parameters of the student DNN 501 (specifically, the weights of the nodes in the layers comprising the student DNN feature extraction unit 205) are updated based on the evaluation (step S170). In step S165, when it is not determined to repeat, that is, when it is determined to terminate the training, the learning system 300 provides the trained student DNN 501 (step S180).

For example, when a DNN is implemented in a device such as a mobile terminal, the student DNN model 500 is an object of the implementation. Providing a trained student DNN 501 means that an implementable student DNN 501 to a device has been determined.

Next, a more specific example will be described with reference to FIG. 1.

The data set and the label to be learned as a regression problem is prepared. Then, the first DNN model whose size is large enough to learn the data set is selected as a teacher model and the first DNN model is made learn.

In the teacher model a weight learned using a random number or some data set, for example, is set as an initial value. During learning, a subset of the data set is given to the teacher DNN feature extraction unit 203. The output value yₒᵤₜₚᵤₜ from the teacher DNN estimate calculation unit 204 and the value of the label y_{label} are compared. A function of the difference between the output value yₒᵤₜₚᵤₜ and the label value y_{label}, for example, the mean square error (Σ(yₒᵤₜₚᵤₜ−y_{label})²/N) is calculated. The process of comparison and the process of calculation are performed by a teacher feature learning unit, for example, not shown in FIG. 1.

Then, in the direction of decreasing the value of the function, the gradient is calculated using error back propagation or the like, and the weight parameters are updated using stochastic gradient descent or the like. The process of calculating the gradient and updating the weight parameters is continued until certain determination criteria, for example, the mean square error of the output and the label becomes less than a certain threshold value. By the above process, the teacher DNN 401 is obtained. The processes of calculating the gradient and updating the weight parameters are performed by the teacher feature learning unit for example, which is not shown in FIG. 1.

Similar to the teacher DNN401, a weight learned by using a random number or some data set is also set to the student DNN501 as an initial value.

During learning, a subset of the data set is given to the teacher DNN feature extraction unit 203 and the student DNN feature extraction unit 205. The values z_{teacher} and z_{student} of the final layers (refer to FIG. 3) of the teacher DNN feature extraction unit 203 and the student DNN feature extraction unit 205, and the outputs y_{teacher} and y_{student,i} of the teacher DNN estimate calculation unit 204 and the student DNN estimate calculation unit 206 are calculated. Since the student DNN estimate calculation unit 206 outputs multiple data, the values of the outputs are marked with the subscript i.

The student DNN feature learning unit 207 calculates a function of the difference between z_{teacher} and z_{student}, for example, a mean square error (Σ(z_{student}−z_{teacher})²/N). It should be noted that the student DNN feature learning unit 207 aligns both dimensions when the output dimensions of the feature outputs z_{teacher} and z_{student} of the teacher DNN401 and the student DNN501 are different. For example, the student DNN feature learning unit 207 causes an appropriate CNN to act on the feature output of the teacher DNN. For example, the output of the intermediate layer whose dimension is intended to be aligned is fed to the convolutional layer, and the dimension is adjusted by the convolutional operation.

The output of the teacher DNN estimate calculation unit 204 is used for label correction in the noisy label correction unit 208. When determining whether the label is a noisy label or not, such a method is used that the estimate of the teacher DNN 401 is compared with the value of the label, and when the difference is smaller than a certain threshold value, it is considered as a correct label, and when the difference is larger than the certain threshold value, it is considered to be an incorrect label (noisy label), for example.

For example, the student DNN learning unit 209 calculates the mean squared error (Σ(y_{student,1}−y_{teacher})2/N) between the output y_{student,1} of the student DNN estimate calculation unit 206 of i=1 and the output y_{teacher} of the teacher DNN estimate calculation unit 204. In addition, the student DNN learning unit 209 calculates a function of the difference between the output y_{student,2} of the student DNN estimate calculation unit 206 of i=2 and the label value y_{label}, reflecting the result of the noisy label correction unit 208.

For example, the student DNN learning unit 209 calculates the weighted mean squared error (Σw^{j}(y^{j}_{student,1}−y^{j}_{teacher})²/N) and sets the weight w=0 for the label that is determined to be an incorrect label and w=1 is set for the other labels.

Then, the student DNN learning unit 209 then calculates a gradient using error back propagation or the like in the direction of decreasing the value of the calculated plurality of difference functions. In addition, the student DNN learning unit 209 updates the weight parameters using a stochastic gradient descent method or the like. As described above, the student DNN learning unit 209 updates the weights in the student DNN so that there is no difference between the feature extracted by the teacher DNN feature extraction unit 203 and the feature extracted by the student DNN feature extraction unit 205, while reducing the influence of the label including noise.

The process of updating the weight parameters is continued until certain determination criteria, for example, the mean square error of the output and the label becomes less than a certain threshold value. By the above process, the student DNN 501 is obtained.

When the student DNN 501 outputs the estimate after the learning is completed, the output integration unit 210 calculates a statistical average of the output, for example. The output unit 211 outputs the statistical average as the final estimate.

Next, the effects of the first example embodiment of the learning system will be described.

In this example embodiment, the student DNN 501 learns by using the student DNN feature learning unit 207 so that the output of the student DNN feature extraction unit 205 reproduces the output of the teacher DNN feature extraction unit 203. As a result, the learning system can efficiently make the student DNN learn the information learned by the teacher DNN. In general, when the student DNN 501 is made learn to reproduce the teacher DNN 401, there is a degree of freedom as to which output of the teacher DNN 401 is learned. The output of the final layer of the feature extraction unit of the DNN corresponds to the basis vector in the case of a linear regression device. Being able to reproduce the basis vector means that the feature extractor of the teacher DNN 401 has been completely reproduced. If the basis vectors can be reproduced, learning is generally easy.

In addition, it is possible to reduce learning difficulties caused by incorrect labels. This is because the teacher DNN 401 implicitly learns whether the label of the training data is correct or incorrect in the process of learning. Then, in the teacher DNN 401, the noisy label correction unit 208 judges whether the input label is an incorrect label or not by comparing the output of the teacher DNN estimate calculation unit 204 with the label data supplied from the label reading unit 202 and corrects the incorrect label.

Furthermore, it is possible to reduce the statistical error in the output of the student DNN 501. This is because, in general, the output of the DNN includes random statistical errors, but in this example embodiment, multiple results are output to the student DNN 501 and the output integration unit 210 takes a statistical average of those outputs.

### Example Embodiment 2

In the learning system of the second example embodiment, the student DNN 501 receives the output from any layer other than the final layer in the teacher DNN 401.

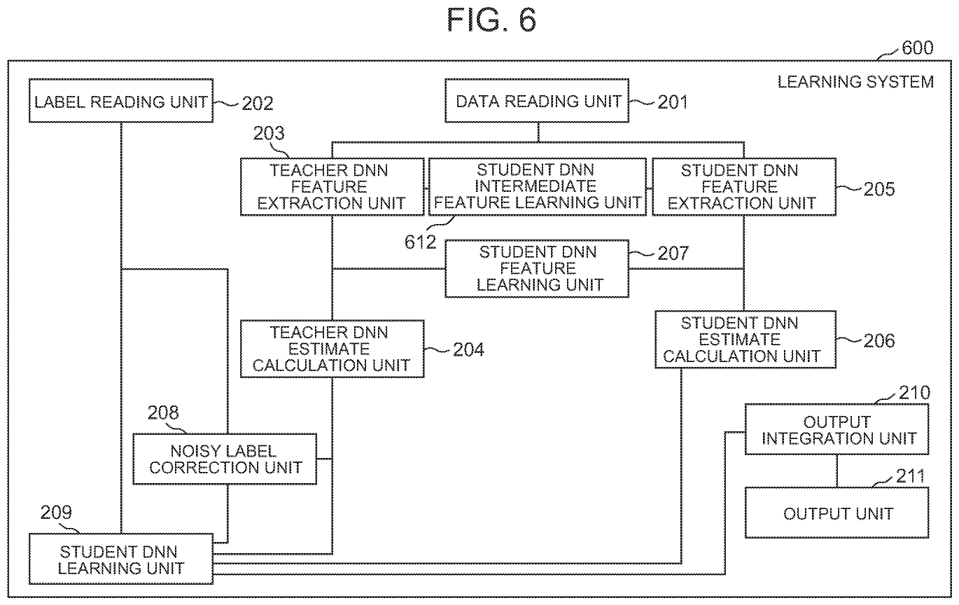

The configuration of the learning system according to this example embodiment will be described. FIG. 6 is a block diagram showing a configuration example of a learning system. A learning system 600 of the second example embodiment includes the data reading unit 201, the label reading unit 202, the teacher DNN feature extraction unit 203, the teacher DNN estimate calculation unit 204, the student DNN feature extraction unit 205, the student DNN estimate calculation unit 206, the student DNN feature learning unit 207, the noisy label correction unit 208, the student DNN learning unit 209, the output integration unit 210, and the output unit 211. The learning system 600 further includes a student DNN intermediate feature learning unit 612.

The student DNN intermediate feature learning unit 612 inputs outputs from any layer other than the final layer from the teacher DNN feature extraction unit 203 and the student DNN feature extraction unit 205. The student DNN intermediate feature learning unit 612 calculates a function of the difference between them. The student DNN intermediate feature learning unit 612 calculates a gradient that reduces the function of the difference and uses it to update the weights of the student DNN.

The configuration other than the student DNN intermediate feature learning unit 612 is the same as the configuration of the learning system 200 of the first example embodiment.

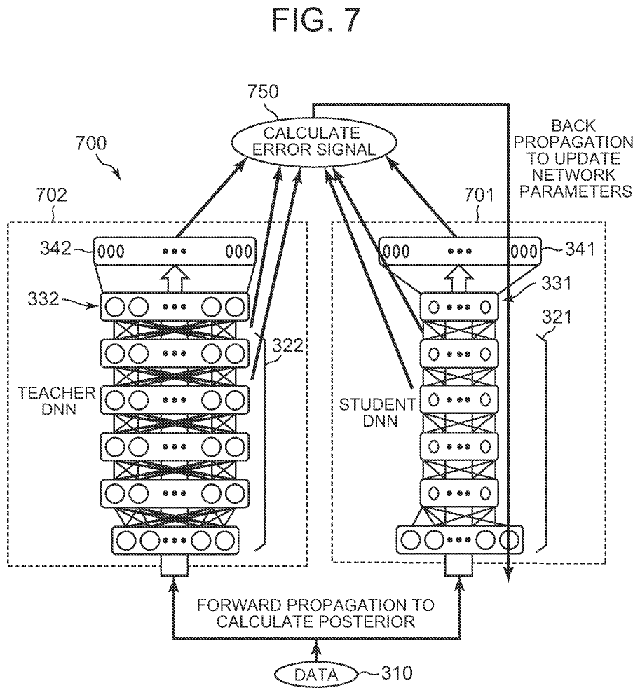

FIG. 7 is an explanatory diagram showing an example of a learning system of DNN of the second example embodiment. A learning system 700, similar to the learning system 300 shown in FIG. 2, includes a student DNN 701 and a teacher DNN 702. The learning system 700 is the same system as the learning system 600 shown in FIG. 6, although the representation method is different.

An example of training (learning) a student DNN with a small number of parameters will be described by using the output of the teacher DNN with a large number of parameters instead of the correct answer label, with reference to FIG. 7.

The student DNN 701 inputs data (training data) from the data reading unit 310. The feature extraction unit 321 converts the data into a feature. The estimate calculation unit 331 converts the feature into an estimate 341.

The teacher DNN 702 inputs data (training data) from the data reading unit 310. The feature extraction unit 322 converts the data into a feature. The estimate calculation unit 332 converts the feature into an estimate 342.

In the learning system 700, the error signal calculation unit 750 calculates an error signal from the obtained feature of the final layer, the feature of the intermediate layer, and each estimate. Then, the learning system 700 updates the weights by back propagation to update the network parameters of student DNN 701.

The learning system 600 performs the same processing as the processing of the learning system 200 of the first example embodiment shown in the flowchart of FIG. 5. However, in this example embodiment, the processes of steps S140 and S160 are different from the processes in the first example embodiment.

That is, in step S140, the student DNN 501 (specifically, the student DNN estimate calculation unit 206) also executes a process of inputting a feature (intermediate feature) from the intermediate layer in the teacher DNN401. When there is a plurality of intermediate layers in the teacher DNN 401, the student DNN 501 inputs a feature from one or a plurality of predetermined intermediate layers.

In step S160, the student DNN 501 (specifically, the student DNN learning unit 209) also executes a process of comparing the feature obtained from the intermediate layer in the teacher DNN 401 with the feature obtained from the intermediate layer in the student DNN 501.

In this example embodiment, by making the student DNN501 learn the intermediate feature of the teacher DNN 401, more knowledge of the teacher DNN 401 can be transmitted to the student DNN 501.

The learning systems 200, 600 of the above example embodiments can be applied to devices that handle regression problems. As an example, when an object detector is constructed with a DNN, the position of an object can be handled as a regression problem. In addition, a human body and posture of an object can also be treated as a regression problem.

The functions (processes) in the above exemplary embodiments may be realized by a computer having a processor such as a central processing unit (CPU), a memory, etc. For example, a program for performing the method (processing) in the above exemplary embodiments may be stored in a storage device (storage medium), and the functions may be realized with the CPU executing the program stored in the storage device.

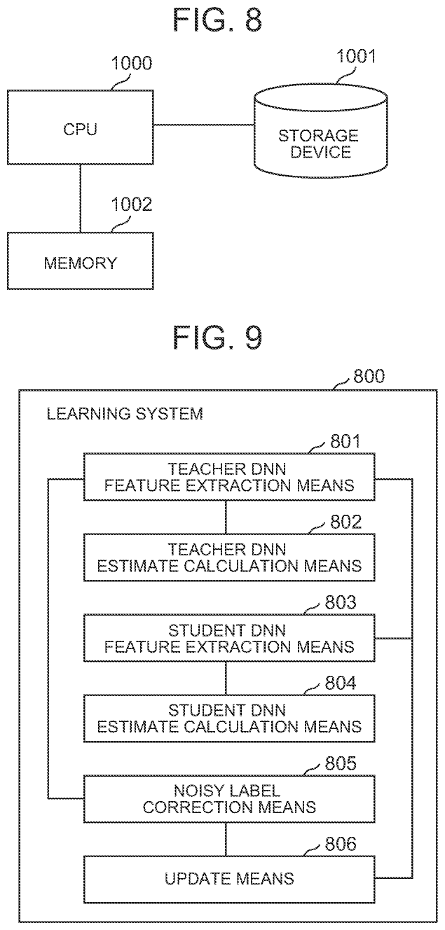

FIG. 8 is a block diagram showing an example of the computer having a CPU. The computer is implemented in a learning system. The CPU 1000 executes processing in accordance with a program stored in a storage device 1001 to realize the functions in the above exemplary embodiments. That is, the computer realizes the functions of the teacher DNN feature extraction unit 203, the teacher DNN estimate calculation unit 204, the student DNN feature extraction unit 205, the student DNN estimate calculation unit 206, the student DNN feature learning unit 207, the student noisy label correction unit 208, the student DNN learning unit 209, and the output integration unit 210 shown in FIGS. 1 and 7.

The storage device 1001 is, for example, a non-transitory computer readable media. The non-transitory computer readable medium is one of various types of tangible storage media. Specific examples of the non-transitory computer readable media include a magnetic storage medium (for example, hard disk), a magneto-optical storage medium (for example, magneto-optical disc), a compact disc-read only memory (CD-ROM), a compact disc-recordable (CD-R), a compact disc-rewritable (CD-R/W), and a semiconductor memory (for example, a mask ROM, a programmable ROM (PROM), an erasable PROM (EPROM), a flash ROM).

The program may be stored in various types of transitory computer readable media. The transitory computer readable medium is supplied with the program through, for example, a wired or wireless communication channel, or, through electric signals, optical signals, or electromagnetic waves.

A memory 1002 is a storage means implemented by a RAM (Random Access Memory), for example, and temporarily stores data when the CPU 1000 executes processing. It can be assumed that a program held in the storage device 1001 or a temporary computer readable medium is transferred to the memory 1002 and the CPU 1000 executes processing based on the program in the memory 1002.

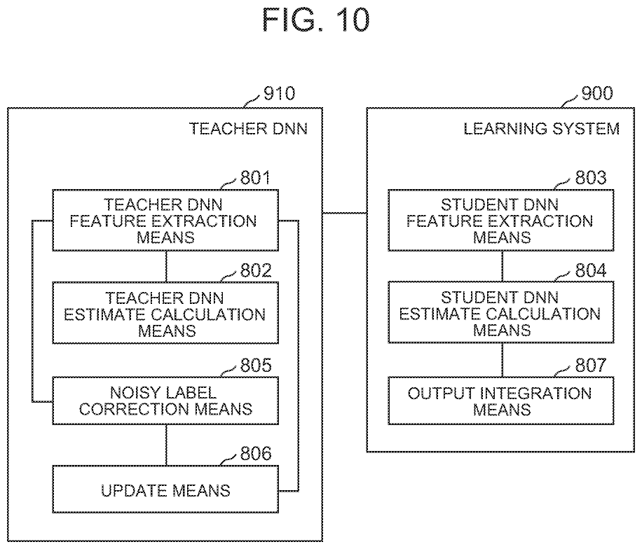

FIG. 9 is a block diagram showing the main part of a learning system according to the present invention. The learning system 800 comprises teacher DNN feature extraction means 801 (for example, the teacher DNN feature extraction unit 203) for extracting a feature of each of a plurality of training data, teacher DNN estimate calculation means 802 (for example, the teacher DNN estimate calculation unit 204) for calculating a first estimate of a label corresponding to each of the training data, student DNN feature extraction means 803 (for example, the student DNN feature extraction unit 205) for extracting a feature of each of the training data, student DNN estimate calculation means 804 (for example, the student DNN estimate calculation unit 206) for calculating a second estimate of a label corresponding to each of the training data, noisy label correction means 805 (for example, the noisy label correction unit 208) for determining whether or not the label corresponding to the training data is a label containing a noise, based on the label corresponding to the training data and the first estimate, and update means 806 (for example, the the student DNN learning unit 209) for updating weights in the student DNN so as to reduce a difference between the feature extracted by the teacher DNN feature extraction means 801 and the feature extracted by the student DNN feature extraction means 803 while decreasing an influence of the label containing the noise.

FIG. 10 is a block diagram showing the main part of a learning device according to the present invention. The learning device 900 comprises student DNN feature extraction means 803 (for example, the student DNN feature extraction unit 205) for extracting a feature of input data, student DNN estimate calculation means 804 (for example, the student DNN estimate calculation unit 206) for calculating a plurality of estimates of labels corresponding to the input data, and output integration means 807 (for example, the output integration unit 210) for integrating the estimates, wherein weights of the student DNN feature extraction means 803 are updated by teacher DNN 910 includes teacher DNN feature extraction means 801 (for example, the teacher DNN feature extraction unit 203) for extracting a feature of each of a plurality of training data, teacher DNN estimate calculation means 802 (for example, the teacher DNN estimate calculation unit 204) for calculating a first estimate of a label corresponding to each of the training data, noisy label correction means 805 (for example, the noisy label correction unit 208) for determining whether or not the label corresponding to the training data is a label containing a noise, based on the label corresponding to the training data and the first estimate, and update means 806 (for example, the student DNN learning unit 209) for updating the weights in the student DNN so as to reduce a difference between the feature extracted by the teacher DNN feature extraction means 801 and the feature extracted by the student DNN feature extraction means 803 while decreasing an influence of the label containing the noise.

A part of or all of the above example embodiments may also be described as, but not limited to, the following supplementary notes.

(Supplementary note 1) A learning system that uses a teacher DNN (Deep Neural Network) and a student DNN whose size is smaller than a size of the teacher DNN comprising:

teacher DNN feature extraction means for extracting a feature of each of a plurality of training data,

teacher DNN estimate calculation means for calculating a first estimate of a label corresponding to each of the training data,

student DNN feature extraction means for extracting a feature of each of the training data,

student DNN estimate calculation means for calculating a second estimate of a label corresponding to each of the training data,

noisy label correction means for determining whether or not the label corresponding to the training data is a label including a noise, based on the label corresponding to the training data and the first estimate, and

update means for updating weights in the student DNN so as to reduce a difference between the feature extracted by the teacher DNN feature extraction means and the feature extracted by the student DNN feature extraction means while decreasing an influence of the label including the noise.

(Supplementary note 2) The learning system according to Supplementary note 1, wherein

the update means decreases the influence of the label including the noise in a function representing differences between a plurality of the first estimates and a plurality of the second estimates, calculates a value of the function, and updates the weights of nodes in a layer of the student DNN according to a calculation result.

(Supplementary note 3) The learning system according to Supplementary note 2, wherein

the update means calculates a gradient that reduces the value of the function and updates the weights using a gradient descent method.

(Supplementary note 4) The learning system according to any one of Supplementary notes 1 to 3, wherein

the noisy label correction means corrects the label when the label corresponding to the training data is determined to be the label including the noise.

(Supplementary note 5) A learning device that uses a student DNN comprising:

student DNN feature extraction means for extracting a feature of input data,

student DNN estimate calculation means for calculating a plurality of estimates of labels corresponding to the input data, and

output integration means for integrating the estimates,

wherein weights of the student DNN feature extraction means are updated by teacher DNN includes

teacher DNN feature extraction means for extracting a feature of each of a plurality of training data,

teacher DNN estimate calculation means for calculating a first estimate of a label corresponding to each of the training data,

noisy label correction means for determining whether or not the label corresponding to the training data is a label including a noise, based on the label corresponding to the training data and the first estimate, and

update means for updating the weights in the student DNN so as to reduce a difference between the feature extracted by the teacher DNN feature extraction means and the feature extracted by the student DNN feature extraction means while decreasing an influence of the label including the noise.

(Supplementary note 6) A learning method that uses a teacher DNN and a student DNN of whose size is smaller than a size of the teacher DNN comprising:

extracting a feature of each of a plurality of training data as a teacher DNN feature,

calculating a first estimate of a label corresponding to each of the training data,

extracting a feature of each of the training data as a student DNN feature,

calculating a second estimate of a label corresponding to each of the training data,

determining whether or not the label corresponding to the training data is a label including a noise, based on the label corresponding to the training data and the first estimate, and

updating weights in the student DNN so as to reduce a difference between the extracted teacher DNN feature and the extracted student DNN feature.

(Supplementary note 7) The learning method according to Supplementary note 6, further comprising

decreasing the influence of the label including the noise in a function representing differences between a plurality of the first estimates and a plurality of the second estimates, calculating a value of the function, and updating the weights of nodes in a layer of the student DNN according to a calculation result.

(Supplementary note 8) The learning method according to Supplementary note 7, further comprising

calculating a gradient that reduces the value of the function and updates the weights using a gradient descent method.

(Supplementary note 9) The learning method according to any one of Supplementary notes 6 to 8, further comprising

correcting the label when the noisy label correction means determines that the label corresponding to the training data is the label including the noise.

(Supplementary note 10) A computer readable recording medium storing a learning program, the learning program causing a processor to execute:

a process of extracting a feature of each of a plurality of training data as a teacher DNN feature,

a process of calculating a first estimate of a label corresponding to each of the training data,

a process of extracting a feature of each of the training data as a student DNN feature,

a process of calculating a second estimate of a label corresponding to each of the training data,

a process of determining whether or not the label corresponding to the training data is a label including a noise, based on the label corresponding to the training data and the first estimate, and

a process of updating weights in the student DNN so as to reduce a difference between the extracted teacher DNN feature and the extracted student DNN feature.

(Supplementary note 11) The recording medium according to Supplementary note 10, wherein

the learning program causes the processor to execute

a process of decreasing the influence of the label including the noise in a function representing differences between a plurality of the first estimates and a plurality of the second estimates, calculating a value of the function, and updating the weights of nodes in a layer of the student DNN according to a calculation result.

(Supplementary note 12) The recording medium according to Supplementary note 11, wherein

the learning program causes the processor to execute

a process of calculating a gradient that reduces the value of the function and updates the weights using a gradient descent method.

(Supplementary note 13) The recording medium according to any one of Supplementary notes 10 to 12, wherein

the learning program causes the processor to execute

a process of correcting the label when the noisy label correction means determines that the label corresponding to the training data is the label including the noise.

(Supplementary note 14) A learning program causing a computer to execute:

a process of extracting a feature of each of a plurality of training data as a teacher DNN feature,

a process of calculating a first estimate of a label corresponding to each of the training data,

a process of extracting a feature of each of the training data as a student DNN feature,

a process of calculating a second estimate of a label corresponding to each of the training data,

a process of determining whether or not the label corresponding to the training data is a label including a noise, based on the label corresponding to the training data and the first estimate, and

a process of updating weights in the student DNN so as to reduce a difference between the extracted teacher DNN feature and the extracted student DNN feature.

(Supplementary note 15) The learning program according to Supplementary note 14, causing the computer to execute

a process of decreasing the influence of the label including the noise in a function representing differences between a plurality of the first estimates and a plurality of the second estimates, calculating a value of the function, and updating the weights of nodes in a layer of the student DNN according to a calculation result.

(Supplementary note 16) The learning program according to Supplementary note 15, causing the computer to execute

a process of calculating a gradient that reduces the value of the function and updates the weights using a gradient descent method.

(Supplementary note 17) The learning program according to any one of Supplementary notes 14 to 16, causing the computer to execute

a process of correcting the label when the noisy label correction means determines that the label corresponding to the training data is the label including the noise.

Although the invention of the present application has been described above with reference to example embodiments, the present invention is not limited to the above example embodiments. Various changes can be made to the configuration and details of the present invention that can be understood by those skilled in the art within the scope of the present invention.

### REFERENCE SIGNS LIST

200, 600, 700 Learning system

201, 310, 402 Data reading unit

202 Label reading unit

203 Teacher DNN feature extraction unit

204 Teacher DNN estimate calculation unit

205 Student DNN feature extraction unit

206 Student DNN estimate calculation unit

207 Student DNN feature learning unit

208 Noisy Label correction unit

209 Student DNN learning unit

210 Output integration unit

211 Output unit

300 Learning system

301, 501, 701 Student DNN

302, 401, 702 Teacher DNN

350, 750 Error signal calculation unit

403, 503 Node

404, 504 Hidden layer

500 Student DNN model

612 Student DNN intermediate feature learning unit

800 Learning system

801 Teacher DNN feature extraction means

802 Teacher DNN estimate calculation means

803 Student DNN feature extraction means

804 Student DNN estimate calculation means

805 Noisy Label correction means

806 Update means

807 Output integration means

900 Learning device

910 Teacher DNN

What is claimed is:

1. A learning system that uses a teacher DNN (Deep Neural Network) and a student DNN whose size is smaller than a size of the teacher DNN comprising:
one or more memories storing instructions, and
one or more processors configured to execute the instructions to
extract a feature of each of a plurality of training data as a teacher DNN feature,
calculate a first estimate of a label corresponding to each of the training data,
extract a feature of each of the training data as a student DNN feature,
calculate a second estimate of a label corresponding to each of the training data,
determine whether or not the label corresponding to the training data is a label including a noise, based on the label corresponding to the training data and the first estimate, and
update weights in the student DNN so as to reduce a difference between the extracted teacher DNN feature and the extracted student DNN feature while decreasing an influence of the label including the noise.

2. The learning system according to claim 1, wherein
the one or more processors configured to further execute the instructions to decrease the influence of the label including the noise in a function representing differences between a plurality of the first estimates and a plurality of the second estimates, calculate a value of the function, and update the weights of nodes in a layer of the student DNN according to a calculation result.

3. The learning system according to claim 2, wherein
the one or more processors configured to further execute the instructions to calculate a gradient that reduces the value of the function and updates the weights using a gradient descent method.

4. The learning system according to claim 1, wherein
the one or more processors configured to further execute the instructions to correct the label when the label corresponding to the training data is determined to be the label including the noise.

5. (canceled)

6. A learning method, implemented by a processor, that uses a teacher DNN and a student DNN of whose size is smaller than a size of the teacher DNN comprising:
extracting a feature of each of a plurality of training data as a teacher DNN feature,
calculating a first estimate of a label corresponding to each of the training data,
extracting a feature of each of the training data as a student DNN feature,
calculating a second estimate of a label corresponding to each of the training data,
determining whether or not the label corresponding to the training data is a label including a noise, based on the label corresponding to the training data and the first estimate, and
updating weights in the student DNN so as to reduce a difference between the extracted teacher DNN feature and the extracted student DNN feature.

7. The learning method according to claim 6, further comprising
decreasing the influence of the label including the noise in a function representing differences between a plurality of the first estimates and a plurality of the second estimates, calculating a value of the function, and updating the weights of nodes in a layer of the student DNN according to a calculation result.

8. The learning method according to claim 7, further comprising
calculating a gradient that reduces the value of the function and updates the weights using a gradient descent method.

9. The learning method according to claim 6, further comprising
correcting the label when the noisy label correction means determines that the label corresponding to the training data is the label including the noise.

10. A non-transitory computer readable information recording medium storing a learning program, when executed by a processor, perform:
a process of extracting a feature of each of a plurality of training data as a teacher DNN feature,
a process of calculating a first estimate of a label corresponding to each of the training data,
a process of extracting a feature of each of the training data as a student DNN feature,
a process of calculating a second estimate of a label corresponding to each of the training data,
a process of determining whether or not the label corresponding to the training data is a label including a noise, based on the label corresponding to the training data and the first estimate, and
a process of updating weights in the student DNN so as to reduce a difference between the extracted teacher DNN feature and the extracted student DNN feature.

11. The non-transitory computer readable information recording medium according to claim 10, wherein
when executed by the processor, the learning program further performs
a process of decreasing the influence of the label including the noise in a function representing differences between a plurality of the first estimates and a plurality of the second estimates, calculating a value of the function, and updating the weights of nodes in a layer of the student DNN according to a calculation result.

12. The non-transitory computer readable information recording medium according to claim 11, wherein
when executed by the processor, the learning program further performs
a process of calculating a gradient that reduces the value of the function and updates the weights using a gradient descent method.

13. The non-transitory computer readable information recording medium according to claim 10, wherein
when executed by the processor, the learning program further performs
a process of correcting the label when the noisy label correction means determines that the label corresponding to the training data is the label including the noise.
